(19) United States
(12) Patent Application Publication
(10) Pub. No.: US 2017/0097632 A1
(43) Pub. Date: Apr. 6, 2017

(54) METHOD OF CLOUD DATA SERVICES OF INDUSTRIAL PROCESS AUTOMATION SYSTEMS

(71) Applicant: HONGTAO YOU, SUGAR LAND, TX (US)

(72) Inventor: HONGTAO YOU, SUGAR LAND, TX (US)

(21) Appl. No.: 14/874,712

(22) Filed: Oct. 5, 2015

(51) Int. Cl. G05B 19/418

(52) U.S. Cl. CPC G05B 19/41835; G05B 2219/33148

(57) ABSTRACT

This invention provides a method of cloud data services of industrial process automation systems. It can be used by clients such as a client application, a client system, or even end users (personnel). It is generic without a custom and lengthy configuration for any specific industrial process automation system of industrial processes. It automatically discovers the interested configuration information of an industrial process automation system, and provides configuration data, runtime data, alarm/event records, and historical data to clients. It allows clients to search for data items based on process orientated criteria. It tracks clients' search criteria, keeps client selected data items in data groups with multi-part namespace, which data groups can be shared among end users. It calculates the view-count of a data group and the popularity of a data item contained in data groups, which will help the sort of client query results. By opening a data group, client will be able to access the interested data from industrial process automation systems.

### TECHNICAL FIELD

The invention is relates to industrial process automation systems.

### BACKGROUND OF THE INVENTION

An industrial process automation system, called Automation System hereinafter, is used to monitor and control industrial manufacturing and/or material transportation processes, such as a production line, a chemical plant production unit, or a pipeline. All Automation Systems are proprietary developed by manufacturers. Most Automation Systems, if not all, consist of all or portions of traditional and/or smart instrumentation, programmable logic controllers and/or process controllers, server computers and/or computer workstations, and networking infrastructure for different network layers such as instrumentation networks, process control networks, and computer networks.

An industrial manufacturing and/or material transportation process is monitored and controlled by a number of points that have analog or discrete values. These points are measured by instruments, and their values represent the status of the process. These points can be inputs (for monitoring) and/or outputs (for control). The process controller of an Automation System may have algorithms that take inputs of the process plus certain parameters of control settings, and calculate the outputs to monitor and/or control the process.

An Automation System always has a configuration database, which contains the definitions of all process points to be monitored and/or controlled, and control algorithms. The configuration database also contains all parameters that will determine the Automation System behaviors.

From the operational data point of view, an Automation System will always provide users with field process input data measured by instrumentation and control outputs of control algorithms. The Automation System will respond to users' actions including event acknowledgment, setpoint changes, and commands for the system to perform. The operational data of a process point can be categorized into real-time data, historical data, and transitional data records. A real-time data of the point can be identified by a tagname, and its data value is normally associated with data quality and timestamp. Historical data of the point can also be identified by the same tagname corresponding to the real-time data tagname of the same point. Historical data of the point will consist of a list of data values in a time line, in which list each historical value is associated with data quality and timestamp. A transitional data record of the point, such as an alarm/event record, consists of a number of columns of information for a data transition or a user action, in which columns there are at least columns being the tagname of the point, transition time stamp, transition type and/or state, transition value, etc.

The data structure of an Automation System can vary from different system manufacturers. Some data structures are tag based. Each tag represents a process point. The value of the tag is the value of the process point. A tag has a number of parameters providing the point information, such as description, engineering unit, scaling, alarm limits, etc. Some data structures are object-orientated. An object will have one or more equivalent tags that are normally called attributes of the object. An object usually represents a physical process object such as a valve or a pump. Some data structures can be hybrid. Methods of identifying tags or objects can vary from different types of Automation Systems. Some Automation Systems will identify the tag or object by using a unique tagname. Some will use structural multi-part naming convention like a hierarchical namespace. Some will support both a unique tagname and a hierarchical namespace.

Traditionally, an Automation System is located at manufacturing physical location(s). All equipment of the Automation System is physically identified, whether the Automation System is stand-alone or distributed. The Automation System provides users with a specifically developed human machine interface (called HMI hereinafter), which is unique to the custom configured Automation System.

There is technology of service based interface such as OPC UA that provides data access to external client applications. It is not based on cloud computing. This technology can allows clients to browse the list of runtime data items of Automation Systems. It does not have a search capability.

There are mobile applications available for end users to access data of Automation Systems via mobile devices. They are not based on cloud computing, but are just mobile HMIs.

An Automation System often contains a large amount of data, i.e. tens of thousands, hundreds of thousands, and even millions of data items. Currently, without custom developed HMI by technical personnel, end users will not practically be able to consume the data of the Automation System in order to monitor and control the process. End users can vary from operators, field maintenance technicians, process engineers, system engineers, production planners or schedulers, business management directors, etc. Data consumption for different types of end users can be very different.

### SUMMARY OF THE INVENTION

This invention provides a method of cloud data services of Automation Systems, called Cloud Data Services hereinafter. It is used by clients such as client applications, client systems, or even end users (personnel). Other than deploying the Cloud Data Services and specifying the selected Automation Systems, a Cloud Data Services does not need specific lengthy configuration for a specific Automation System by technical personnel for end users. The deployment of a Cloud Data Services is independent of the actual industrial manufacturing and/or material transportation processes.

Given that the Automation System is accessible via application programming interface (so called API hereinafter) or other open interfaces, and given that the Cloud Data Services knows the identification of the Automation System, the Cloud Data Services will automatically discover all interested configuration data of the Automation System. It means that the Cloud Data Services does not intend to duplicate the full configuration of the Automation System, and the information discovered will generally interest end users. With the discovered configuration information of the Automation System, the Cloud Data Services will be able to provide the real-time data, historical data, and transitional data records of the Automation System to end users.

A Cloud Data Services provides end users with searching capabilities. The searching criteria can include but not be limited to the following: object and/or tag identification such as tagname or hierarchical namespace, process unit or area that the object or tag belongs to, object or tag description, measurement type based on data engineering unit, data sources like a field device, and other factors specific for certain types of Automation Systems. Search is process orientated.

A Cloud Data Services will track end users' search criteria.

An end user can group the searched and selected data items into a collection (called Data Group hereinafter). A Data Group will be identified by a multi-part namespace, such as a hierarchical group name. A Data Group can be private to the end user who creates it, or can be shared to other users.

End users will open Data Groups, therefore, access the selected data of Automation Systems.

The view-count of a Data Group is the number of openings by end users with weighing factor of open duration. The longer an open duration is, the more contribution to the view-count is. The view-count of a Data Group is the popularity of a Data Group. It can be used to sort the Data Groups of end users.

A Cloud Data Services calculates the data popularity of a data item that has been contained in at least one Data Group. The Data popularity of a data item is the number of Data Groups that contain this data item, with weighing factor of view-count of Data Group. Higher the view-count is, the more contribution to the data popularity is. Data popularity is used to sort the data search results for end users.

A Cloud Data Services allows different types of end users easily to search their interested data, to organize data into Data Group, and to consume the data via Data Group. It does not need any customized HMI developed by technical personnel for different types of end users. A Data Group can be shared to others, so that end users may not have to build up all of their Data Groups from scratch.

### BRIEF DESCRIPTION OF THE DRAWINGS

The invention may best be understood by reference to the following description taken in conjunction with the accompanying drawings in which:

FIG. 1 is a perspective basic diagram of computer software components that accomplish the invented method of cloud data services of industrial process automation systems.

FIG. 2 is a perspective diagram of computer software components that accomplish the invented method of cloud data services of industrial process automation systems, comprising all modules in FIG. 1, and further an alarm/event interface.

FIG. 3 is a perspective diagram of computer software components that accomplish the invented method of cloud data services of industrial process automation systems, comprising all modules in FIG. 1, and further a historian interface and an optional alarm/event interface.

FIG. 4 is a perspective diagram of computer software components that accomplish the invented method of cloud data services of industrial process automation systems, comprising all modules in FIG. 1, and further a database module, an optional alarm/event interface, and an optional historian interface.

FIG. 5 is a perspective diagram of computer software components that accomplish the invented method of cloud data services of industrial process automation systems, comprising all modules in FIG. 4, and further a web site that allows end users to use a web browser to directly use the implemented Cloud Data Services, without a special developed client application.

FIG. 6 is a perspective diagram of computer software components that accomplish the invented method of cloud data services of industrial process automation systems, comprising all modules in FIG. 4, and further a mobile application that allows end users to use a mobile device to directly use the implemented Cloud Data Services.

### DETAILED DESCRIPTION OF THE INVENTION

There exist today a number of proprietary Automation Systems such as a distributed control system (so called DCS) or a supervisory control and data acquisition system (so called SCADA). An Automation System is physically located together with manufacturing processes, and dedicated for monitoring and control of the processes. Local HMI consoles are dedicated for local operator use. With today's technology, certain computer servers and/or workstations are virtualized to better utilize computer hardware. The client applications including HMIs are custom developed or pre-configured to consume the pre-configured data in specific formats and pages for different types of end users. Also, there can be remote access of HMI for remote users. Furthermore, there can be various web applications that provide various customized information for various types of users.

This invention provides a generic Cloud Data Services for the supported types of Automation Systems. The supported types of Automation Systems are referred to as the systems from which a Cloud Data Services is able to access the interested data via specially developed interfaces.

In FIG. 1, Block 100 is the block diagram of a typical Automation System. The actual system may not have all modules (Block 101, Block 102, Block 103, and Block 104) as described here. Multiple Automation Systems can be connected to a Cloud Data Services. Block 100 is not part of Cloud Data Services.

Block 101 is the system configuration repository of an Automation System. The data format of system configuration may be proprietary. API shall be available from the manufacturer. Block 201 of a Cloud Data Services will access this system configuration repository to automatically discover all interested configuration data of the Automation System.

Block 102 is the runtime module of an Automation System, which module consists of all runtime object instances or tags. API shall be available from manufacturer. Or an open interface shall be available, for example an OPC interface. Block 202 of a Cloud Data Services will access and provide the runtime data to clients. Block 201 can also access this module, since certain Automation Systems may have an integrated module for both configuration information and runtime data.

Block 103 is the alarm/event record module of an Automation System, which module contains all runtime and/or historical alarm/event records. Block 201 can access this module, since this module may contain certain data change events that are related to runtime configuration changes.

Block 104 is the real-time data history module of an Automation System, also called historian, which module has large amount of historical data of real-time object attributes or tags. Block 201 can also access this historian, since the historian may contain the specific configuration information that is not in Block 101.

In FIG. 1, Block 200 is the block diagram of a basic interface services of a Cloud Data Services, called Interface Services hereinafter. Each of Block 200 will support one type of Automation Systems. Multiple types of Block 200 can support multiple types of Automation Systems.

Block 201 is the discovery interface. It is able to automatically discover the interested system configuration of the connected Automation System, mainly from Block 101, and also from Block 102, Block 103, and Block 104. A discovery interface also provides configuration data access to clients, so that clients can directly access system configuration of the connected Automation System. The interested configuration information is referred to as the portion of configuration of the Automation System that the discovery interface provides to clients. A discovery interface calculates the system summary and statistics. It also automatically tracks the interested runtime change events, where the interested runtime change event is referred to as the event from which the newly changed data value will be kept in the discovery interface.

A discovery interface allows clients to search for data items in an industrial process automation system based on process orientated criteria, where the examples of process orientated criteria include but not limited to the tagname or hierarchical namespace of the object and/or attribute/tag, process unit or area where the object belongs to, instrument type based on engineering unit, description, input or output, data source, alarm priority, etc. With process orientated search capability, clients can easily find the interested data items without using custom developed HMI by technical personnel.

A discovery interface tracks client search criteria; allows a client to store selected data items into data groups which are created and/or modified by the client, are identified by the client specified multi-part namespace, and can be shared to other clients; and allows a client to save the other client's shared data group as its own data group by specifying a new multi-part namespace. With client orientated data groups, a discovery interface provides a truly generic Cloud Data Services that does not need custom configuration and custom developed HMI for various types of Automation Systems and/or end users.

A discovery interface calculates a view-count of a data group, where the view-count is the number of data group openings by clients with weighing factor of opening duration. An example is a linear algorithm that the view-count of a data group is the sum of opening durations in seconds. The view-count of a data group reflects the popularity and/or importance of the data group. When clients query the list of data groups, the view-counts of data groups can be used to sort the list, therefore, clients can easily pick the mostly viewed data groups.

A discovery interface calculates a popularity of a data item that has been contained in at least one data group, where the popularity is the number of data groups that contain the same data item, with weighing factor of view-count of data group. An example is a linear algorithm that the popularity of a data item is the sum of view-counts of data groups that contain the data item. The popularity of a data item reflects the importance of the data item from the client point of view. When clients search for data items with process orientated search criteria, the popularities of data items can be used to sort the returned data items, therefore, clients can easily find and select the more important data items.

Block 202 is the runtime interface. It interfaces with the runtime module—Block 102 of the connected Automation System. It provides runtime data access to clients, so that clients can get the runtime data of the connected Automation System.

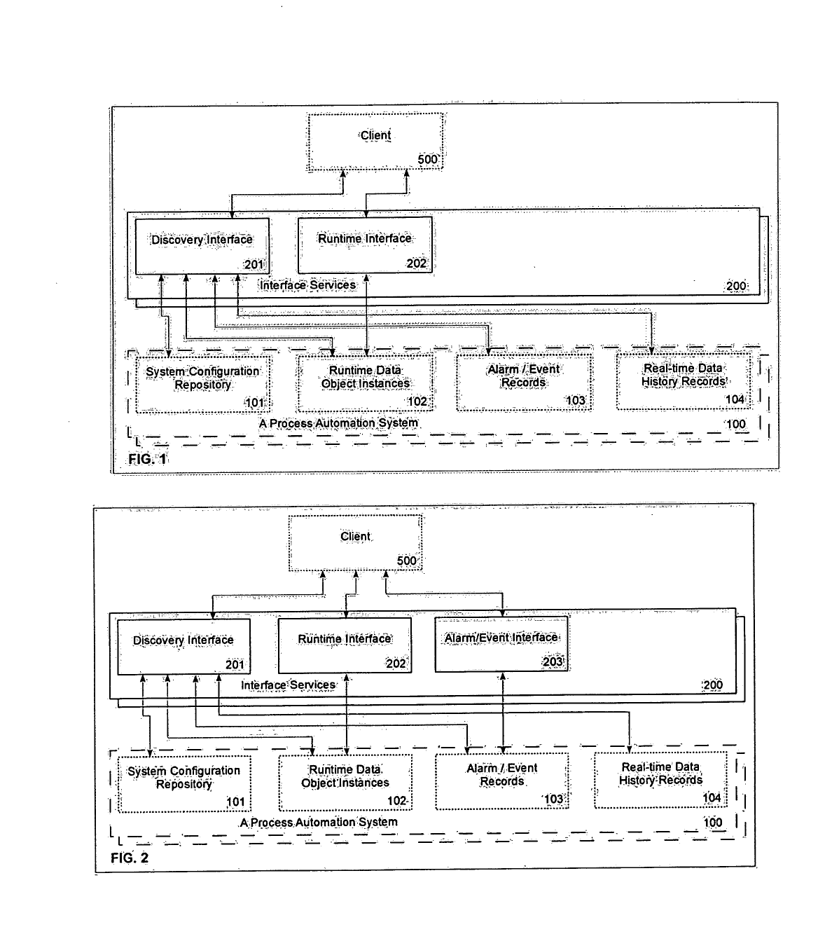

FIG. 2 includes all modules in FIG. 1. Interface Services—Block 200 further comprises an alarm/event interface—Block 203.

Block 203 is the alarm/event access interface. It interfaces with the alarm/event record module—Block 103 of the connected Automation System. It provides alarm/event record access to clients, so that clients can get the alarm/event record data of the connected Automation System.

FIG. 3 includes all modules in FIG. 1. Interface Services—Block 200 further comprises a historian interface—Block 204. There are two implementation options of Block 200, one with an alarm/event interface—Block 203, while the other one without the alarm/event interface—Block 203.

Block 204 is the historian interface. It interfaces with the historian module—Block 104 of the connected Automation System. It provides runtime data history access to clients, so that clients can get the historical data of the connected Automation System.

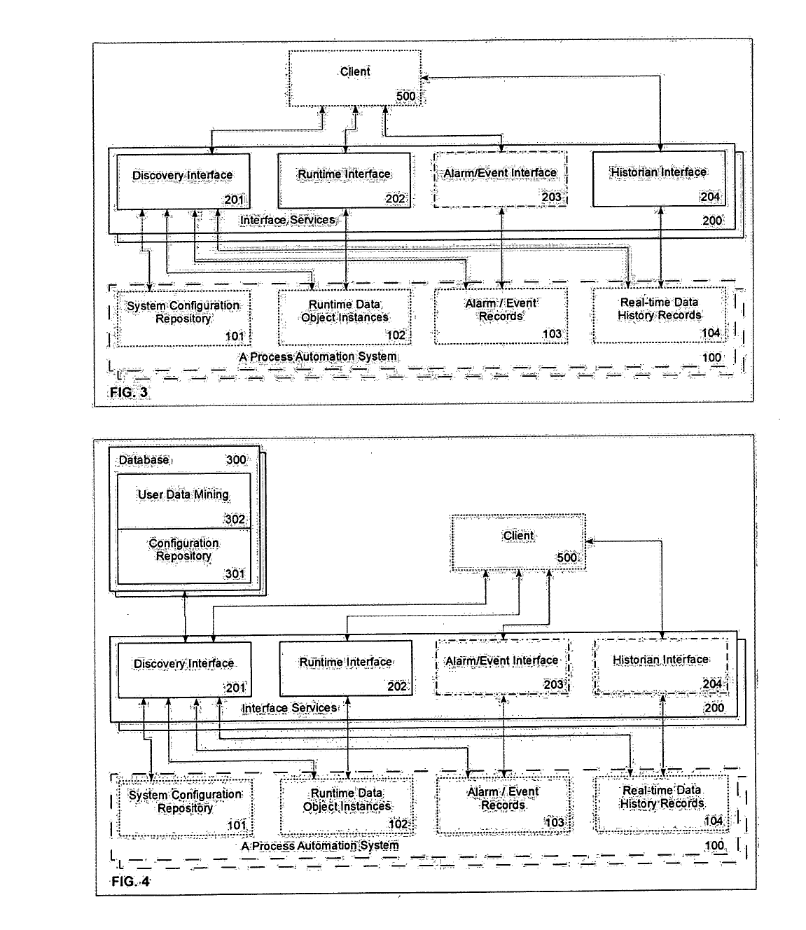

FIG. 4 includes all modules in FIG. 1. Each Block 200 may have an optional alarm/event interface and/or an optional historian interface. Furthermore, a Cloud Data Service comprises at least one database module—Block 300, each database module being associated with a discovery interface—Block 201 in a Block 200.

In FIG. 4, Block 300 is the block diagram of typical database module of a Cloud Data Services. Each of Block 300 is associated with a discovery interface—Block 201 in Block 200, and will support one type of Automation Systems. Multiple types of Block 300 can support multiple types of Automation Systems.

Block 301 is the configuration repository. It contains all interested configuration information and system summary & statistics of the connected Automation System discovered and calculated by a discovery interface—Block 201.

Block 302 is the user data mining. It stores clients' search criteria and clients' data groups with all associated parameters such as view-counts of data groups and popularities of data items contained in data groups.

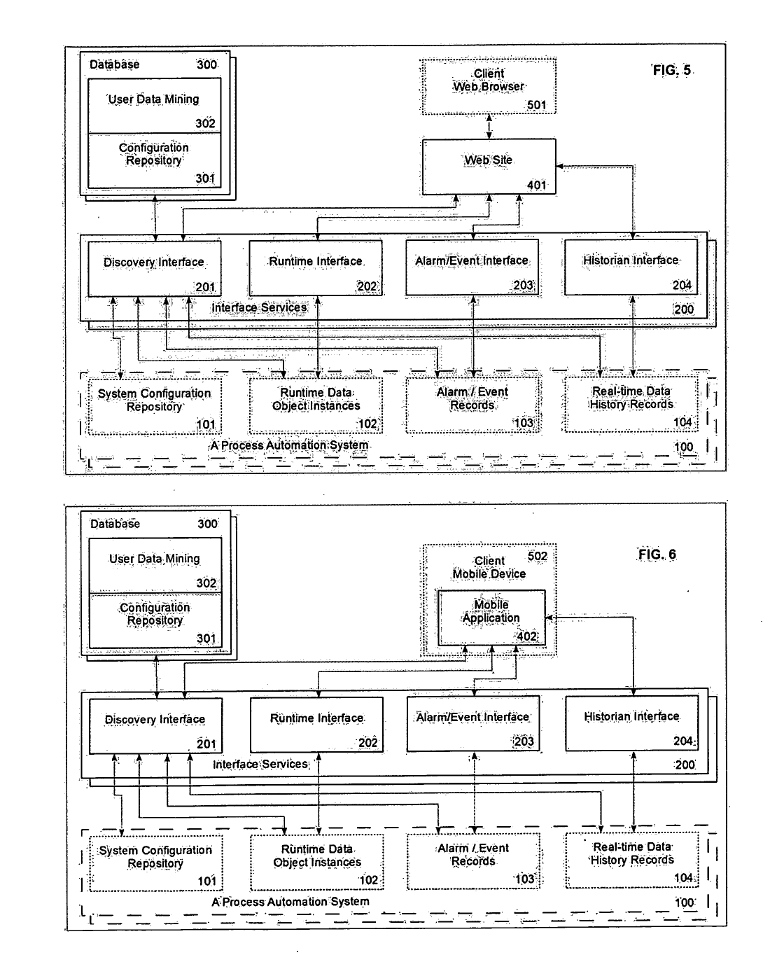

FIG. 5 includes all modules in FIG. 4. It further comprises a web site—Block 401 that allows end users to use a web browser to directly use the implemented Cloud Data Services, without a special developed client application. The web site—Block 401 can access multiple Block 200s for multiple Automation Systems. FIG. 5 is just one options of multiple configurations. A minimum configuration comprises a discovery interface—Block 201, a runtime interface—Block 202, and a web site—Block 401. Interface Services—Block 200 can further comprise an alarm/event interface, further a historian interface. Furthermore, a database module—Block 300 can be comprised and associated with the discovery interface—Block 201.

FIG. 6 includes all modules in FIG. 4. It further comprises a mobile application—Block 402 that is installed in a client mobile device such as a smart phone or a tablet. It is developed for a Cloud Data Services. It allows end users to use a mobile device to directly use the implemented Cloud Data Services. The mobile application—Block 402 can access multiple Block 200s for multiple Automation Systems. FIG. 6 is just one options of multiple configurations. A minimum configuration comprises a discovery interface—Block 201, a runtime interface—Block 202, and a web site—Block 401. Interface Services—Block 200 can further comprise an alarm/event interface, further a historian interface. Furthermore, a database module—Block 300 can be comprised and associated with the discovery interface—Block 201.

What is claimed is:

1. A cloud computing hardware/software implemented method of cloud data services of industrial process automation systems, comprising:
at least one discovery interface, each discovery interface accessing configuration data of at least one industrial process automation system and providing the configuration access to clients; and
at least one runtime interface, each runtime interface providing runtime data access of an industrial process automation system to clients.

2. The method of claim 1 wherein each discovery interface automatically discovers the interested configuration data of at least one industrial process automation system and calculates the system summary and statistics, where the interested configuration information is referred to as the portion of configuration of the industrial process automation system that the method of claim 1 provides to clients; automatically tracks the interested runtime change events, where the interested runtime change event is referred to as the event from which the newly changed data value will be kept in the discovery interface.

3. The method of claim 1 further comprises at least one alarm/event interface, each alarm/event interface providing alarm/event record access of at least one industrial process automation system to clients.

4. The method of claim 1 or claim 3 further comprises at least one historian interface, each historian interface providing historical data access of at least one industrial process automation system to clients.

5. The method of claim 1 wherein each discovery interface allows clients to search for data items in an industrial process automation system based on process orientated criteria, where the examples of process orientated criteria include but not limited to the tagname or hierarchical namespace of the object and/or attribute/tag, process unit or area where the object belongs to, instrument type based on engineering unit, description, input or output, data source, alarm priority, etc.

6. The method of claim 5 wherein each discovery interface tracks client search criteria; allows a client to store selected data items into data groups which are created and/or modified by the client, are identified by the client specified multi-part namespace, and can be shared to other clients; and allows a client to save the other client's shared data group as its own data group by specifying a new multi-part namespace.

7. The method of claim 6 wherein each discovery, interface calculates a view-count of a data group, where the view-count is the number of data group openings by clients with weighing factor of opening duration.

8. The method of claim 7 wherein each discovery interface calculates a popularity of a data item that has been contained in at least one data group, where the popularity is the number of data groups that contain the same data item, with weighing factor of view-count of data group.

9. The method of one of claims 1 to 8 further comprises at least one database module, each database module being associated with one discovery interface, comprising: a configuration repository being used to store configuration data discovered by the discovery interface; and a user data mining module being used to store the system summary and statistics, and to further store client search criteria and client data groups.

10. The method of one of claims 1 to 9 further comprises a human interface that is a web site implemented by cloud computing hardware/software, and allows an end user to use a web browser to search data, to save selected data items into data groups, and to open data groups for accessing data from industrial process automation systems.

11. The method of one of claims 1 to 9 further comprises a human interface that is a mobile application, and allows an end user to use a mobile device to search data, to save selected data items into data groups, and to open data groups for accessing data from industrial process automation systems.
